(19) United States
(12) Patent Application Publication
(10) Pub. No.: US 2006/0114497 A1
(43) Pub. Date: Jun. 1, 2006

(54) Printing system

(75) Inventors: David G. Anderson, Ontario, NY (US); Dusan G. Lysy, Fairport, NY (US); Steven R. Moore, Rochester, NY (US); Charles A. Radulski, Macedon, NY (US); Robert M. Lofthus, Webster, NY (US)

Correspondence Address: Ann M. Skerry, Esq.;FAY, SHARPE, FAGAN, MINNICH & McKEE,LLP, SEVENTH FLOOR, 1100 SUPERIOR AVENUE, CLEVELAND, OH, 44114-2579, US

(73) Assignee: XEROX CORPORATION

(21) Appl. No.: 11/212,367

(22) Filed: Aug. 26, 2005

Related U.S. Application Data
(60) Provisional application No. 60/631,651, filed on Nov. 30, 2004.

(51) Int. Cl. G06F 3/12

(52) U.S. Cl. 358/1.15; 358/1.13

(57) ABSTRACT

A printing system includes a monochrome marking engine for printing monochrome images and a color marking engine which can print both color and monochrome images. A previewer identifies attributes of the print job, for example, for each page, identifying any monochrome and color images. A user interface enables a user to select a print mode for the print job from a plurality of print modes. A scheduler is responsive to the previewer and the user interface for assigning pages of the print job among the marking engines based on the attributes of the print job and the user-selected print mode. A marking engine controller is in communication with the scheduler for controlling the at least one monochrome marking engine to render pages of the print job assigned thereto and for controlling the at least one color marking engine to render pages of the print job assigned thereto.

### CROSS-REFERENCE TO RELATED APPLICATIONS

This application claims the priority of U.S. Provisional Application Ser. No. 60/631,651 (Attorney Docket No. 20031830-US-PSP), filed Nov. 30, 2004, entitled “TIGHTLY INTEGRATED PARALLEL PRINTING ARCHITECTURE MAKING USE OF COMBINED COLOR AND MONOCHROME ENGINES,” by David G. Anderson, et al., which is incorporated herein in its entirety, by reference.

### BACKGROUND

The present exemplary embodiment relates generally to a printing system containing at least a first marking engine and a second marking engine and more particularly concerns a printing system comprising a monochrome marking engine and a color marking engine with an integral paper path which enables user selection from a plurality of print modes, each print mode according different weights to achieving certain goals, such as run cost, productivity, and image quality, in the printing of a print job.

In a typical xerographic marking device, such as a copier or printer, a photoconductive insulating member is charged to a uniform potential and thereafter exposed to a light image of an original document to be reproduced. The exposure discharges the photoconductive insulating surface in exposed or background areas and creates an electrostatic latent image on the member, which corresponds to the image areas contained within the document. Subsequently, the electrostatic latent image on the photoconductive insulating surface is made visible by developing the image with a developing material. Generally, the developing material comprises toner particles adhering triboelectrically to carrier granules. The developed image is subsequently transferred to a print medium, such as a sheet of paper. The fusing of the toner onto paper is generally accomplished by applying heat to the toner with a heated roller and application of pressure. In multi-color printing, successive latent images corresponding to different colors are recorded on the photoconductive surface and developed with toner of a complementary color. The single color toner images are successively transferred to the copy paper to create a multi-layered toner image on the paper. The multi-layered toner image is permanently affixed to the copy paper in the fusing process.

A common trend in the office equipment market, particularly in relation to copiers and printers, is to organize a machine on a modular basis, wherein certain distinct subsystems of the machine are bundled together into modules which can be readily removed from the machine and replaced with new modules of the same type. A modular design facilitates servicing and repair, since a representative of the service provider simply removes the defective module. Actual repair of the module can take place off site, at the service provider's premises. Recently, printing systems have been developed which include a plurality of marking engine modules. These systems enable high overall outputs to be achieved by printing portions of the same document on multiple printers. Such systems are commonly referred to as “tandem engine” printers, “parallel” printers, or “cluster printing” (in which an electronic print job may be split up for distributed higher productivity printing by different marking engines, such as separate printing of the color and monochrome pages).

In such machines, color marking engines which print with cyan, magenta, and yellow (CMY) as well as black (K) toners allow printing of both color and black images on a single marking engine. However, the cost of producing black prints on a color marking engine is often higher than for a dedicated monochrome device. One reason for this is that the color components are often cycled, even during black printing. Although in some systems, the color components can be disabled during the production of monochrome prints, this tends to increase mechanical complexity to provide for retraction of the color components and to disengage their drives. Another reason for the higher cost is that the marking engine may provide a certain interdocument color toner throughput to control toner age in the system. Another source of increased cost is that the black toner in the CMYK marking engines is generally made xerographically compatible with the C, M & Y toners, which often makes the toner formulation more complex and thus more expensive than that required for a monochrome marking engine.

### REFERENCES

The following references, the disclosures of which are incorporated herein by reference in their entireties, variously relate to “tandem engine” printers, “parallel” printers, “cluster printing,” and “output merger” or “interposer” systems: U.S. Pat. No. 5,568,246 to Keller, et al., U.S. Pat. No. 4,587,532 to Asano, U.S. Pat. No. 5,570,172 to Acquaviva, U.S. Pat. No. 5,596,416 to Barry, et al.; U.S. Pat. No. 5,995,721 to Rourke et al; U.S. Pat. No. 4,579,446 to Fujino; U.S. Pat. No. 5,389,969 to Soler, et al.; a 1991 “Xerox Disclosure Journal” publication of November-December 1991, Vol. 16, No. 6, pp. 381-383 by Paul F. Morgan; and a Xerox Aug 3, 2001 “TAX” publication product announcement entitled “Cluster Printing Solution Announced.”

### CROSS-REFERENCE TO RELATED APPLICATIONS

The following applications, the disclosures of each being totally incorporated herein by reference are mentioned:

U.S. Provisional Patent Application Ser. No. 60/631,918 (Attorney Docket No. 20031867-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. Provisional Patent Application Ser. No. 60/631,921 (Attorney Docket No. 20031867Q-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. application Ser. No. 10/761,522 (Attorney Docket A2423-US-NP), filed Jan. 21, 2004, entitled “HIGH RATE PRINT MERGING AND FINISHING SYSTEM FOR PARALLEL PRINTING,” by Barry P. Mandel, et al.;

U.S. application Ser. No. 10/785,211 (Attorney Docket A3249P1-US-NP), filed Feb. 24, 2004, entitled “UNIVERSAL FLEXIBLE PLURAL PRINTER TO PLURAL FINISHER SHEET INTEGRATION SYSTEM,” by Robert M. Lofthus, et al.;

U.S. application Ser. No. 10/881,619 (Attorney Docket A0723-US-NP), filed Jun. 30, 2004, entitled “FLEXIBLE PAPER PATH USING MULTIDIRECTIONAL PATH MODULES,” by Daniel G. Bobrow.;

U.S. application Ser. No. 10/917,676 (Attorney Docket A3404-US-NP), filed Aug. 13, 2004, entitled “MULTIPLE OBJECT SOURCES CONTROLLED AND/OR SELECTED BASED ON A COMMON SENSOR,” by Robert M. Lofthus, et al.;

U.S. application Ser. No. 10/917,768 (Attorney Docket 20040184-US-NP), filed Aug. 13, 2004, entitled “PARALLEL PRINTING ARCHITECTURE CONSISTING OF CONTAINERIZED IMAGE MARKING ENGINES AND MEDIA FEEDER MODULES,” by Robert M. Lofthus, et al.;

U.S. application Ser. No. 10/924,106 (Attorney Docket A4050-US-NP), filed Aug. 23, 2004, entitled “PRINTING SYSTEM WITH HORIZONTAL HIGHWAY AND SINGLE PASS DUPLEX,” by Lofthus, et al.;

U.S. application Ser. No. 10/924,113 (Attorney Docket A3190-US-NP), filed Aug. 23, 2004, entitled “PRINTING SYSTEM WITH INVERTER DISPOSED FOR MEDIA VELOCITY BUFFERING AND REGISTRATION,” by Joannes N. M. deJong, et al.;

U.S. application Ser. No. 10/924,458 (Attorney Docket A3548-US-NP), filed Aug. 23, 2004, entitled “PRINT SEQUENCE SCHEDULING FOR RELIABILITY,” by Robert M. Lofthus, et al.;

U.S. application Ser. No. 10/924,459 (Attorney Docket No. A3419-US-NP), filed Aug. 23, 2004, entitled “PARALLEL PRINTING ARCHITECTURE USING IMAGE MARKING ENGINE MODULES (as amended),” by Barry P. Mandel, et al;

U.S. application Ser. No. 10/933,556 (Attorney Docket No. A3405-US-NP), filed Sep. 3, 2004, entitled “SUBSTRATE INVERTER SYSTEMS AND METHODS,” by Stan A. Spencer, et al.;

U.S. application Ser. No. 10/953,953 (Attorney Docket No. A3546-US-NP), filed Sep. 29, 2004, entitled “CUSTOMIZED SET POINT CONTROL FOR OUTPUT STABILITY IN A TIPP ARCHITECTURE,” by Charles A. Radulski et al.;

U.S. application Ser. No. 10/999,326 (Attorney Docket 20040314-US-NP), filed Nov. 30, 2004, entitled “SEMI-AUTOMATIC IMAGE QUALITY ADJUSTMENT FOR MULTIPLE MARKING ENGINE SYSTEMS,” by Robert E. Grace, et al.;

U.S. application Ser. No. 10/999,450 (Attorney Docket No. 20040985-US-NP), filed Nov. 30, 2004, entitled “ADDRESSABLE FUSING FOR AN INTEGRATED PRINTING SYSTEM,” by Robert M. Lofthus, et al.;

U.S. application Ser. No. 11/000,158 (Attorney Docket No. 20040503-US-NP), filed Nov. 30, 2004, entitled “GLOSSING SYSTEM FOR USE IN A TIPP ARCHITECTURE,” by Bryan J. Roof;

U.S. application Ser. No. 11/000,168 (Attorney Docket No. 20021985-US-NP), filed Nov. 30, 2004, entitled “ADDRESSABLE FUSING AND HEATING METHODS AND APPARATUS,” by David K. Biegelsen, et al.;

U.S. application Ser. No. 11/000,258 (Attorney Docket No. 20040503Q-US-NP), filed Nov. 30, 2004, entitled “GLOSSING SYSTEM FOR USE IN A TIPP ARCHITECTURE,” by Bryan J. Roof;

U.S. application Ser. No. 11/001,890 (Attorney Docket A2423-US-DIV), filed Dec. 2, 2004, entitled “HIGH RATE PRINT MERGING AND FINISHING SYSTEM FOR PARALLEL PRINTING,” by Robert M. Lofthus, et al.;

U.S. Pat. No. 6,925,283 (Attorney Docket A2423-US-DIV1), issued Aug. 2, 2005, entitled “HIGH PRINT RATE MERGING AND FINISHING SYSTEM FOR PARALLEL PRINTING,” by Barry P. Mandel, et al.;

U.S. application Ser. No. 11/051,817 (Attorney Docket 20040447-US-NP), filed Feb. 4, 2005, entitled “PRINTING SYSTEMS,” by Steven R. Moore, et al.;

U.S. application Ser. No. 11/069,020 (Attorney Docket 20040744-US-NP), filed Feb. 28, 2004, entitled “PRINTING SYSTEMS,” by Robert M. Lofthus, et al.;

U.S. application Ser. No. 11/081,473 (Attorney Docket 20040448-US-NP), filed Mar. 16, 2005, entitled “PRINTING SYSTEM,” by Steven R. Moore;

U.S. application Ser. No. 11/089,854 (Attorney Docket 20040241-US-NP), filed Mar. 25, 2005, entitled “SHEET REGISTRATION WITHIN A MEDIA INVERTER,” by Robert A. Clark, et al.;

U.S. application Ser. No. 11/090,498 (Attorney Docket 20040619-US-NP), filed Mar. 25, 2005, entitled “INVERTER WITH RETURN/BYPASS PAPER PATH,” by Robert A. Clark;

U.S. application Ser. No. 11/090,502 (Attorney Docket 20031468-US-NP), filed Mar. 25, 2005, entitled IMAGE QUALITY CONTROL METHOD AND APPARATUS FOR MULTIPLE MARKING ENGINE SYSTEMS,” by Michael C. Mongeon;

U.S. application Ser. No. 11/093,229 (Attorney Docket 20040677-US-NP), filed Mar. 29, 2005, entitled “PRINTING SYSTEM,” by Paul C. Julien;

U.S. application Ser. No. 11/094,864 (Attorney Docket 20040971-US-NP), filed Mar. 31, 2005, entitled “PRINTING SYSTEM,” by Jeremy C. dejong, et al.;

U.S. application Ser. No. 11/094,998 (Attorney Docket 20031520-US-NP), filed Mar. 31, 2005, entitled “PARALLEL PRINTING ARCHITECTURE WITH PARALLEL HORIZONTAL PRINTING MODULES,” by Steven R. Moore, et al.;

U.S. application Ser. No. 11/095,378 (Attorney Docket 20040446-US-NP), filed Mar. 31, 2005, entitled “IMAGE ON PAPER REGISTRATION ALIGNMENT,” by Steven R. Moore, et al.;

U.S. application Ser. No. 11/095,872 (Attorney Docket 20040676-US-NP), filed Mar. 31, 2005, entitled “PRINTING SYSTEM,” by Paul C. Julien;

U.S. application Ser. No. 11/102,355 (Attorney Docket 20041213-US-NP), filed Apr. 8, 2005, entitled “COMMUNICATION IN A DISTRIBUTED SYSTEM,” by Markus P. J. Fromherz, et al.;

U.S. application Ser. No. 11/102,899 (Attorney Docket 20041209-US-NP), filed Apr. 8, 2005, entitled “SYNCHRONIZATION IN A DISTRIBUTED SYSTEM,” by Lara S. Crawford, et al.;

U.S. application Ser. No. 11/102,910 (Attorney Docket 20041210-US-NP), filed Apr. 8, 2005, entitled “COORDINATION IN A DISTRIBUTED SYSTEM,” by Lara S. Crawford, et al.;

U.S. application Ser. No. 11/109,558 (Attorney Docket 19971059-US-NP), filed Apr. 19, 2005, entitled “SYSTEMS AND METHODS FOR REDUCING IMAGE REGISTRATION ERRORS,” by Michael R. Furst, et al.;

U.S. application Ser. No. 11/109,566 (Attorney Docket 20032019-US-NP), filed Apr. 19, 2005, entitled “MEDIA TRANSPORT SYSTEM,” by Barry P. Mandel, et al.;

U.S. application Ser. No. 11/109,996 (Attorney Docket 20040704-US-NP), filed Apr. 20, 2005, entitled “PRINTING SYSTEMS,” by Michael C. Mongeon et al.;

U.S. application Ser. No. 11/122,420 (Attorney Docket 20041149-US-NP), filed May 5, 2005, entitled “PRINTING SYSTEM AND SCHEDULING METHOD,” by Austin L. Richards;

U.S. application Ser. No. 11/136,821 (Attorney Docket 20041238-US-NP), filed May 25, 2005, entitled “AUTOMATED PROMOTION OF MONOCHROME JOBS FOR HLC PRODUCTION PRINTERS,” by David C. Robinson;

U.S. application Ser. No. 11/136,959 (Attorney Docket 20040649-US-NP), filed May 25, 2005, entitled “PRINTING SYSTEMS,” by Kristine A. German, et al.;

U.S. application Ser. No. 11/137,251 (Attorney Docket 20050382-US-NP), filed May 25, 2005, entitled “SCHEDULING SYSTEM,” by Robert M. Lofthus et al.;

U.S. C-I-P application Ser. No. 11/137,273 (Attorney Docket A3546-US-CIP), filed May 25, 2005, entitled “PRINTING SYSTEM,” by David G. Anderson, et al.;

U.S. application Ser. No. 11/137,634 (Attorney Docket 20050281-US-NP), filed May 25, 2005, entitled “PRINTING SYSTEM,” by Robert M. Lofthus, et al.;

U.S. application Ser. No. 11/146,665 (Attorney Docket 20041296-US-NP), filed Jun. 7, 2005, entitled “LOW COST ADJUSTMENT METHOD FOR PRINTING SYSTEMS,” by Michael C. Mongeon;

U.S. application Ser. No. 11/152,275 (Attorney Docket 20040506-US-NP), filed Jun. 14, 2005, entitled “WARM-UP OF MULTIPLE INTEGRATED MARKING ENGINES,” by Bryan J. Roof, et al.;

U.S. application Ser. No. 11/156,778 (Attorney Docket 20040573-US-NP), filed Jun. 20, 2005, entitled “PRINTING PLATFORM,” by Joseph A. Swift;

U.S. application Ser. No. 11/157,598 (Attorney Docket 20041435-US-NP), filed Jun. 21, 2005, entitled “METHOD OF ORDERING JOB QUEUE OF MARKING SYSTEMS,” by Neil A. Frankel;

U.S. application Ser. No. 11/166,299 (Attorney Docket 20041110-US-NP), filed Jun. 24, 2005, entitled “PRINTING SYSTEM,” by Steven R. Moore;

U.S. application Ser. No. 11/166,460 (Attorney Docket 20040505-US-NP), filed Jun. 24, 2005, entitled “GLOSSING SUBSYSTEM FOR A PRINTING DEVICE,” by Bryan J. Roof, et al.;

U.S. application Ser. No. 11/166,581 (Attorney Docket 20040812-US-NP), filed Jun. 24, 2005, entitled “MIXED OUTPUT PRINT CONTROL METHOD AND SYSTEM,” by Joseph H. Lang, et al.;

U.S. application Ser. No. 11/166,961 (Attorney Docket 20041109-US-NP), filed Jun. 24, 2005, entitled “PRINTING SYSTEM SHEET FEEDER,” by Steven R. Moore; and

U.S. application Ser. No. 11/168,152 (Attorney Docket 20020324-US-NP), filed Jun. 28, 2005, entitled “ADDRESSABLE IRRADIATION OF IMAGES,” by Kristine A. German, et al.

### SUMMARY

Aspects of the present disclosure in embodiments thereof include a printing system and a method of printing. In one aspect, the printing system includes at least one monochrome marking engine for printing monochrome images, at least one color marking engine, and a previewer which identifies attributes of a print job comprising a plurality of pages including, for each page of the print job, identifying whether the page includes a monochrome image and identifying whether the page includes a color image. A user interface enables a user to select a print mode for the print job from a plurality of user-selectable print modes. A scheduler is responsive to the previewer and the user interface, for assigning pages of the print job among the marking engines based on the attributes of the print job and the user-selected print mode. At least one marking engine controller is in communication with the scheduler, for controlling the at least one monochrome marking engine to render pages of the print job assigned thereto and for controlling the at least one color marking engine to render pages of the print job assigned thereto.

In another aspect, for a print job having a plurality of pages, in a printing system including at least one monochrome marking engine for printing monochrome images, at least one color marking engine, operatively connected to the monochrome marking engine, a method for printing includes identifying attributes of the print job including, for each page, identifying if the page includes a monochrome image and identifying if the page includes a color image. The method further includes establishing a print mode for the print job from a plurality print modes, the plurality of print modes including at least one user-selectable print mode, assigning pages of the print job among the marking engines based on the attributes of the print job and the user-selected print mode, and controlling the at least one monochrome marking engine to render pages of the print job assigned thereto and for controlling the at least one color marking engine to render pages of the print job assigned thereto.

In another aspect, a xerographic printing system includes at least a first marking engine which prints images of a first type but which does not print images of a second type and at least a second marking engine which prints images of the first type and images of the second type. A user interface enables a user to select a print mode from a plurality of print modes including a first print mode in which all pages of the print job which have an image of the first type are assigned to the first marking engine for printing the image of the first type and in which pages of the print job having an image of the first type and also an image of the second type, are also assigned to the second marking engine for printing images of the second type and a second print mode in which at least a portion of the pages having only images of the first type are assigned to the at least one second marking engine. The printing system executes the print job according to the print mode selected.

### BRIEF DESCRIPTION OF THE DRAWINGS

FIG. 1 is a simplified partially-elevational, partially-schematic view of an exemplary marking engine;

FIG. 2 illustrates an exemplary printing system comprising multiple marking engines; and

FIG. 3 is a sectional view of the exemplary printing system of FIG. 2, incorporating a plurality of marking engines of the type illustrated in FIG. 1.

### DETAILED DESCRIPTION

Aspects of the exemplary embodiment relate to a printing system and a method of printing. The printing exemplary system is configured for printing an electronic print job having a plurality of pages and includes at least one monochrome marking engine and at least one color marking engine. The monochrome marking engine prints monochrome images by using a single colorant, such as black for black images, or a custom color colorant for custom color images. Images, as used herein may include text, graphics, photographs and the like. A page may include both monochrome and color images, either spaced from each other or overprinted one over the other.

The color (P) marking engine has the capability for using more than one colorant, such as cyan, magenta, yellow and optionally also black (CMYK) toners or inks, and may be sometimes be referred to as a process color marking engine. The color marking engine is thus capable of printing both color images, by combinations of colorants, as well as images which would be printed in monochrome if printed by the monochrome marking engine, which will be referred to herein as monochrome images, even though the color printer may use more than one colorant to print the monochrome images. For example a black (K) image is printed with a black colorant when printed on the monochrome marking engine and generally also with a black colorant (K) when printed on a CMYK color marking engine (although it could also be printed with a combination of cyan, magenta, and yellow which approximates black), while a custom color (C) image which can be printed by the monochrome marking engine with a single colorant may use two or more colorants when printed on the color marking engine. Color images are those which can be printed on the color marking engine but not on the monochrome engine. The color marking engine may have a lower productivity (throughput) than the monochrome marking engine. For example, the color making engine may have a maximum productivity of about 50 prints per minute (ppm) whereas the monochrome marking engine may have a maximum productivity of over 100 ppm.

Monochrome marking engines, such as black and custom color marking engines, may be fed with a dyed or pigmented ink or toner, or a premixed ink or toner, which provides a specific color, generally with a higher color rendering accuracy than can be achieved with a process color marking engine. Custom color (C) here is used interchangeably with other terms in the trade, such as signature color, highlight color, or Pantone™ color. While the monochrome marking engine will be described with general reference to a black (K) marking engine it will be appreciated that other monochrome marking engines, such as those which print in custom color (C), are also contemplated.

The color marking engine may be operatively connected to the monochrome marking engine via a common marking engine control system and be arranged in an integrated parallel printing architecture therewith whereby portions of the print job may be performed by different marking engines and then brought together in a common stream.

Each page of the print job may include an image or a set of images which will appear on the same side of a sheet of print media in the executed print job. The identification of images to be associated with a particular page may be determined by a previewer, which previews the print job for attributes, such as job level attributes, page attributes, and image attributes. This may include for each page, identifying whether the page includes a monochrome image and whether the page includes a color image and, by inference, whether the page includes both monochrome and color images. A user interface enables a user to select a mode of printing from a plurality of different print modes for executing the print job.

The control system may include a scheduler, which is responsive to the previewer and the user interface. The scheduler may assign portions of the print job among the marking engines based on the attributes of the print job and the user-selected printing mode. Each of the printing modes applies a different constraint or different set of constraints. The control system may also include a paper path controller, in communication with the scheduler, which controls the monochrome marking engine to render the portions of the print job assigned thereto and controls the color marking engine to render the portions of the print job assigned thereto.

Print medium generally includes a usually flimsy physical sheet of paper, plastic, or other suitable physical print media substrate for images, whether precut or web fed. An electronic print job is normally a set of related images from a particular user, or otherwise related which, when executed by the printing system, form a physical document, such as one or more collated copy sets copied from a set of original print job sheets or electronic document page images. Print job execution involves printing images on front, back, or front and back sides of one or more sheets of paper or other print media. Some sheets may be left completely blank. Some sheets may have both color and black images. Execution of the print job may also involve collating the sheets in a certain order. Still further, the print job may include folding, stapling, punching holes into, or otherwise physically manipulating or binding the sheets.

The exemplary printing system allows a user to select a printing mode from at least two printing modes in which the scheduler applies different constraints for scheduling printing. Depending on the constraints applied, the printing system may in one mode of printing employ a monochrome marking engine or several monochrome marking engines for applying all of the monochrome images and in another mode of printing employ one or more color marking engines for applying at least a portion of the monochrome images. In this way, a user can select, for example, whether the printing system is to favor one of a plurality of goals:

a) increasing printer throughput (a productivity goal), which may be achieved by taking advantage of the ability of color marking engines to print monochrome images,

b) reducing printing cost (an economy goal), which may be achieved by using the more cost efficient marking engine(s), typically the monochrome engine(s), for printing the monochrome images, or

c) improving the consistency of image appearance (such as gloss or color) between images (a quality goal), which may be achieved by using a marking engine or engines which are capable of providing consistency between images, often by using a single color marking engine to print all of the color images.

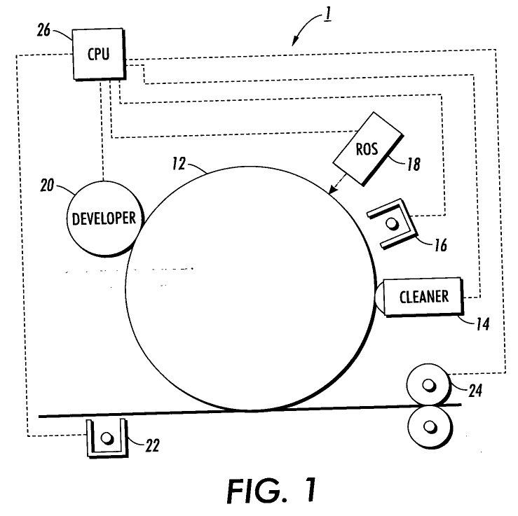

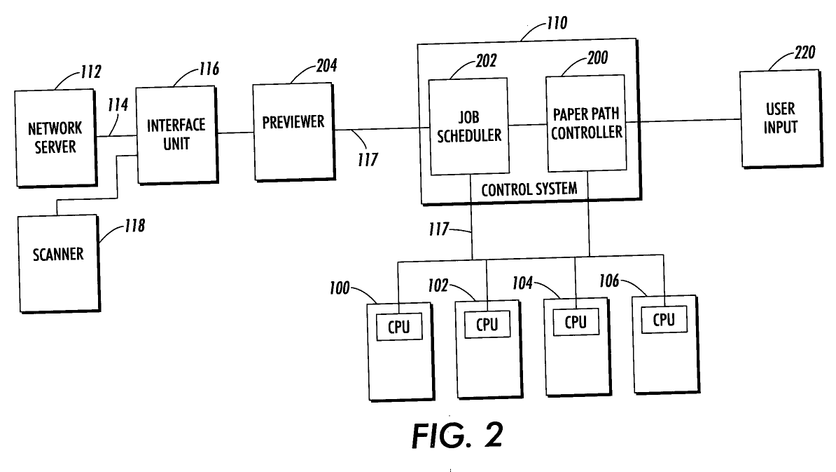

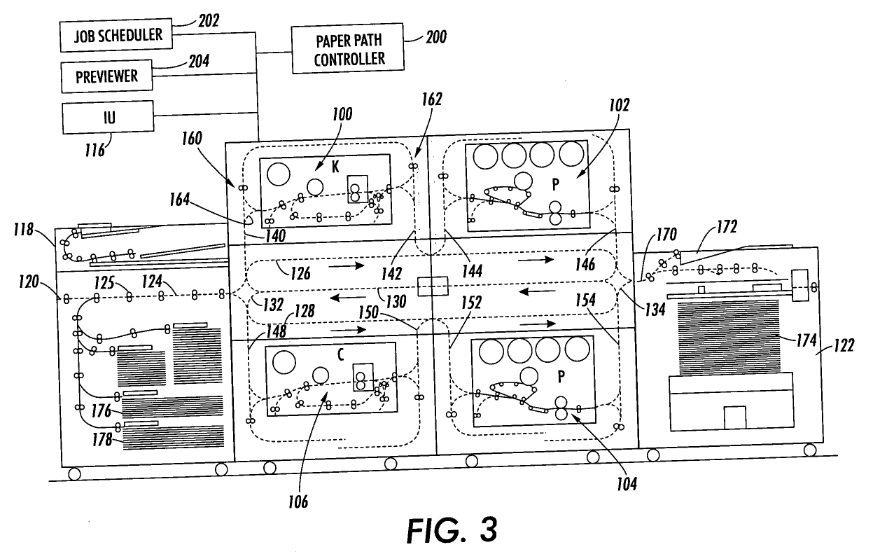

FIG. 1 is a simplified partially-elevational, partially-schematic view of a marking engine 1. The marking engine 1 may serve as a replaceable xerographic module for a printing system 10, such as a xerographic printing system 10, of the type shown in FIGS. 2 and 3. While FIG. 3 illustrates a combination digital copier/printer, the printing system may alternatively be a copier or printer that outputs prints in whatever manner, such as a digital printer, facsimile, or multifunction device, and can create images electrostatographically, by ink-jet, hot-melt, or by any other method. The marking media used by the marking engine can include toner particles, solid or liquid inks, or the like.

The printing system may incorporate “tandem engine” printers, “parallel” printers, “cluster printing,” “output merger,” or “interposer” systems, and the like, as disclosed, for example, in U.S. Pat. Nos. 4,579,446; 4,587,532; 5,489,969 5,568,246; 5,570,172; 5,596,416; 5,995,721; 6,554,276, 6,654,136; 6,607,320, and in copending U.S. application Ser. No. 10/924,459, filed Aug. 23, 2004, for Parallel Printing Architecture Using Image Marking Engine Modules by Mandel, et al., and application Ser. No. 10/917,768, filed Aug. 13, 2004, for Parallel Printing Architecture Consisting of Containerized Image Marking Engines and Media feeder Modules, by Robert Lofthus, the disclosures of all of these references being incorporated herein by reference. A parallel printing system typically feeds paper from a common paper stream to a plurality of printers, which may be horizontally and/or vertically stacked. Printed media from the various printers is then taken from the printer to a finisher where the sheets associated with a single print job are assembled. Variable vertical level, rather than horizontal, input and output sheet path interface connections may be employed, as disclosed, for example, in U.S. Pat. No. 5,326,093 to Sollitt.

The marking engine 1 includes many of the hardware elements employed in the creation of desired images by electrophotographical processes. In the case of a xerographic device, the marking engine typically includes a charge retentive surface, such as a rotating photoreceptor 12 in the form of a belt or drum. The images are created on a surface of the photoreceptor. Disposed at various points around the circumference of the photoreceptor 12 are xerographic subsystems which include a cleaning device generally indicated as 14, a charging station for each of the colors to be applied (one in the case of a monochrome printer, four in the case of a CMYK printer), such as a charging corotron 16, an exposure station 18, which forms a latent image on the photoreceptor such as a Raster Output Scanner (ROS), a developer unit 20, associated with each charging station for developing the latent image formed on the surface of the photoreceptor by applying a toner to obtain a toner image, a transferring unit, such as a transfer corotron 22 transfers the toner image thus formed to the surface of a print media substrate, such as a sheet of paper, and a fuser 24, which fuses the image to the sheet. The fuser generally applies at least one of heat and pressure to the sheet to physically attach the toner and optionally to provide a level of gloss to the printed media. In any particular embodiment of an electrophotographic marking engine, there may be variations on this general outline, such as additional corotrons, cleaning devices, or, in the case of a color printer, multiple developer units. The xerographic subsystems 14, 16, 18, 20, 22, and 24 are controlled by a marking engine controller 26 such as a CPU associated with actuators for each of the subsystems. While the marking engine controller 26 is illustrated as a single unit, it is to be appreciated that the actuators may be distributed throughout the marking engine, for example, located in the xerographic subsystems. The marking engine controller 26 may adjust various xerographic parameters for example Developed Mass Area (DMA), transfer currents, and fuser temperature to produce high quality prints. The marking engine controller 26 may be also linked to other known components, such as a memory, a marking cartridge platform, a marking driver, a function switch, a self-diagnostic unit, all of which can be interconnected by a data/control bus.

With reference to FIG. 2 the printing system 10 includes a plurality of marking engines 100, 102, 104, 106, which may be configured as for the marking engine 1 shown in FIG. 1. The various marking engines are associated for integrated parallel printing of documents within the printing system 10 and are under the control of a common control system 110, which may be located in a suitable central processor, such as a CPU. It will be appreciated that various parts of the control system 110 may be distributed, for example, located in the marking engines, and connected with the central processor by suitable links. The central control system 110 may communicate with the marking engine controllers 26 in order to effectuate a print job. While in the embodiment illustrated in FIG. 2, each marking engine has its own marking engine controller 26, it is to be appreciated that two or more marking engines in the printing system may have a common marking engine controller.

As shown schematically in FIG. 2, each marking engine can receive image data, which can include pixels, in the form of digital image signals for processing from a source of image data, such as computer network/server 112 or scanner 113, by way of a suitable link or communication channel 114, which feeds the signal to an interface unit (IU) 116 of the printing system. While the illustrated interface unit 116 is part of the digital printing system, it is also contemplated that the computer network or the scanner may share or provide the function of converting the digital image data into a utilizable form. A conversion unit, which may be located in the interface unit 116, may convert the image data into an electronic form which is usable by the printing system.

A previewer 204 receives information on the electronic print job from the interface unit 116 and, for a plurality of pages in the print job, identifies page attributes, including any images assigned to the page which require a color printer (color images) and any images which can be printed on either the monochrome engine or color marking engine (such as black images). It will be appreciated that there may be images which can only be printed on a dedicated marking engine which is capable of printing only those images, such as magnetic ink character recognition (MICR) images, although for simplicity, these will not be discussed herein.

The marking engines 100, 102, 104, 106, control system 110, and interface unit 116 are connected by suitable links 118. The links 114, 118 can be wired or wireless links or other means capable of supplying electronic data to and/or from the connected elements. Exemplary links 114, 118 include telephone lines, computer cables, ISDN lines, and the like. As an alternative to a scanner or network server, other remote sources of image data such as a personal computer, floppy disk, hard disk, storage medium, or the like may be envisioned. Typically, a computer network or other image source generates print jobs, wherein each print job includes the image data in the form of a plurality of electronic pages and a set of processing instructions which are sent to the printing system under the direction of a user

In the exemplary architecture of FIG. 3, the four marking engines 100, 102, 104, and 106 are shown interposed between a feeder module 120 and a finishing module 122. At least a first of the marking engines 100, 106 is a monochrome engine, such as black (K) and at least a second of the marking engines 102, 104 is a color (P) marking engine, capable of color printing as well as black (K).

In the embodiment shown in FIG. 3, marking engines 100, 102, 104, and 106 are of the following print modalities, a black marking engine (K), two process color marking engines (P), and a custom color marking engine (C), respectively. As will be appreciated, two or more of the marking engines may be of the same print modality, such as two black (K) and two process color (P) marking engines.

The marking engines 100, 102, 104, 106, are connected with each other and with the feeder module 120 and an output destination 122 by a conveyor system 124 including a network of paper pathways. The conveyor system 124 is controllable for directing print media to a monochrome marking engine 100 or to a color marking engine 102, 104 such that monochrome images can be applied either by a monochrome engine or by a color marking engine. In the illustrated embodiment, the conveyor system 124 is controllable for delivering print media from the feeder module 120 to any one of the marking engines and between any marking engine and any other marking engine in the system. Additionally, the conveyor system 124 enables print media to be printed by two or more of the marking engines contemporaneously. For example, K printing can be performed by monochrome marking engine 100 on a portion of a print job, while at the same time, K printing is performed by the process color marking engine 100 on another portion of the print job.

The job output destination 122 can be any post printing destination where the printed pages of a document are brought together, ordered in a sequence in which they can be assembled into in the finished document, such as a finisher or a temporary holding location. The finisher can be any post-printing accessory device such as an inverter, reverter, sorter, mailbox, inserter, interposer, folder, stapler, collater, stitcher, binder, over-printer, envelope stuffer, postage machine, output tray, or the like.

The conveyor system 124 includes a plurality of drive elements 125, illustrated as pairs of rollers, although other drive elements, such as airjets, spherical balls, and the like are also contemplated. The paper pathway network 124 may include at least one downstream print media highway 126, 128 (two in the illustrated embodiment), and at least one upstream print media highway 130, along which the print media is conveyed in a generally opposite direction to the downstream highways 126, 128 and which may be connected with the upstream highway(s) to form loops. The highways 126, 128, 130 are arranged generally horizontally, and in parallel in the illustrated embodiment, although it is also contemplated that portions of these highways may travel in other directions, including vertically. The main highways 126, 128, 130 are connected at ends thereof with each other, and with the feeder module 120 and finisher module 122, by cloverleaf connection pathways 132, 134.

Pathways 140, 142, 144, 146, 148, 150, 152, 154 etc. feed the print media between the highways 126, 128, 130 and the marking engines 100, 102, 104, 106. The highways 126, 128, 130 and/or pathways 140, 142, 144, 146, 148, 150, 152, 154 may include inverters, reverters, interposers, bypass pathways, and the like as known in the art to direct the print media between the highway and a selected marking engine or between two marking engines. For example, as shown in FIG. 3, each marking engine has an input side inverter 160 and an output side inverter 162 connected with the respective input and output pathways. The network 124 is structured such that one or both the inverters 160, 162 can be bypassed, in the illustrated embodiment, by incorporation of bypass pathways 164 on the input and/or output sides respectively.

As the document is being processed for image transfer through the marking engine 100, the document may be transported at a relatively slower speed, herein referred to as engine marking speed. However, when outside of the marking engine 100, the document can be transported through the interconnecting high speed highways at a relatively higher speed. In inverter assembly 160 a document exiting the highway 126 at a highway speed can be slowed down before entering marking engine 100 by decoupling the document at the inverter from the highway 126 and by receiving the document at one speed into the inverter assembly, adjusting the reversing process direction motor speed to the slower marking engine speed and then transporting the document at slower speed to the marking engine 100. Additionally, if a sheet has been printed in marking engine 100, it can exit the marking engine at the marking engine speed and can be received in the exit inverter assembly 162 at the marking engine speed, be decoupled from the marking engine and transported for re-entering the high speed highway 126 at the highway speed. Additionally, as noted above, any one of the inverter assemblies shown in any of the architectures could also be used to register the document in skew or in a lateral direction.

Print media from the various marking engines and highways is collected as a common stream and delivered by a pathway 170 to the finisher 122. Thus, print media which has been marked by the at least one monochrome marking engine 100, 106, can be delivered to the same output destination as print media which has been marked by one of the at least one color marking engines 102, 104. The finisher 122 may include one or a plurality of output destinations, herein illustrated as output trays 172, 174.

The feeder module 120 may include one or more print media sources, such as paper trays 176, 178, etc. While in the illustrated embodiment, all of the marking engines 100, 102, 104, 106 are fed from a common high speed feeder module 120, it is also contemplated that the marking engines may be associated with separate print media feeders. For example, each marking engine may have its own dedicated print media source or a group of marking engines may be associated with a print media source.

The control system 110 includes a paper path controller 200 which is responsive to a scheduler 202. The paths in which print media documents are directed through the network 124 are controlled by the paper path controller 200, which controls the functions of paper handling. The scheduler 202, through accessing information on the capabilities of the marking engines, schedules an itinerary for a print job. The itinerary provides for the routing of print media to and from appropriate ones of the marking engines 100, 102, 104, and 106 by utilizing appropriate pathways of the conveyor system 124. In creating an itinerary, the scheduler receives and utilizes information about the print job to be printed from the job previewer 204, which may located along with the scheduler 202 and paper path controller 200 within the overall control system 110 for the printing system or elsewhere, such as in the network server or on a personal computer linked to the printing system.

Prior to printing of a print job, which may be realized in the form of a document or plurality of documents, the job previewer 204 may determine overall print job level attributes and image attributes as well as the individual page attributes. The job level attributes may include the number of pages in the print job that have color images on them, the number of pages that have black images on them, and so forth. The page attributes, as discussed above, may include monochrome and color images for each page and may further include other types of images or no images. Where there is more than one type of monochrome image, such as black and custom color, these may be separately identified as page attributes. The image attributes may include color content, line screen frequency and type, and the like. The job previewer may include an algorithm for classifying for each page of the plurality of pages of the print job into a predefined color group selected from a set of color groups, depending on the page attributes. The color groups may include black only (K), where the page has only a black image, custom color only (C), where a page has only a color image, color only (P), where a page has only a color image, and one or more groups for pages having an image of more than one print modality, such as both black and color images or both custom color and black images.

The scheduler 202 schedules the printing of a print job including selection of the marking engines to be used and the route of each sheet of the print job through the system. The scheduler 202 schedules print jobs based on various constraints. The constraints to be applied depend, at least in part, on the printing mode selected by the user. The scheduler 202 confirms with each of the system components, such as marking engines, inverters, etc. that they will be available to perform the desired function, such as printing, inversion, etc., at the designated future time, according to the proposed itinerary.

Various methods of scheduling print media sheets may be employed. For example, U.S. Pat. No. 5,095,342 to Farrell, et al.; U.S. Pat. No. 5,159,395 to Farrell, et al.; U.S. Pat. No. 5,557,367 to Yang, et al.; U.S. Pat. No. 6,097,500 to Fromherz; and U.S. Pat. No. 6,618,167 to Shah; and above mentioned U.S. application Ser. Nos. 10/284,560; 10/284,561; and 10/424,322 to Fromherz, all of which are incorporated herein in their entireties by reference, disclose exemplary job schedulers which can be used to schedule the print sequence herein, with suitable modifications, such as by introducing constraints relating to the printing of monochrome pages.

The exemplary printing system has at least three different printing modes of operation such as a productivity mode, a quality mode, and an economy mode, which favor the goals of productivity, quality, and economy, respectively, over the other two goals. In a given mode, the scheduler applies one or more constraints which may impact productivity, image consistency, and production cost, respectively. One of the modes available to the user may be a default mode which is selected automatically if another print mode is not selected.

Productivity (productivity mode) may be expressed in terms of prints per minute (ppm) of the printing system or the time taken for a job or set of jobs to be completed. In general, the productivity can be increased by having more than one printer printing a portion of the job contemporaneously. For example, black printing may be printed on black pages while color images are being printed on a color marking engine. Where a significant proportion of the pages are black, productivity may be increased by splitting the black pages among two or more marking engines that are available and capable of performing the task, which may result in a portion of the black pages being printed on a color printer and another portion on a black printer.

Image quality (quality mode) may be expressed in terms of the consistency between images, particularly those produced by different marking engines, which may be measured, for example, in terms of gloss of the images and/or color rendering. In general, image consistency is improved by having images of a particular print modality printed on the same or a consistent marking engine.

Production cost (economy mode) may be expressed, for example, in terms of the cost of printing a page or printing a print job. Production cost is generally minimized by having black images printed on a black marking engine and color images printed on a color marking engine.

In selecting a particular mode, a user accepts that other priorities, such as production costs and image quality, in the case of a selected productivity mode, may be sacrificed to some degree.

When a user selects a particular mode, the planner scheduler receives the user selection as an input and applies one or more constraints which are applicable to the printing mode in planning and scheduling an itinerary. Thus, the itinerary planned for one printing mode may employ a different marking engine or engines from that which would be employed another printing mode, although in some cases, the different constraints may result in the same marking engine or engines being used for a given print job.

The constraints which are applied by a particular printing system 10 for a particular print mode may depend on the configuration of the printing system. In general, however, the following constraints may be applied for optimizing a productivity, economy, or quality policy in a single print job:

Productivity Mode

For a black only print job, all pages are assigned to any marking engine capable of printing black.

All pages with any color content are assigned to a color marking engine.

Economy Mode

All pages with any black content have the black content printed on a black marking engine.

Quality Mode

All pages are printed on the same color marking engine unless the print job includes only black pages.

It will be appreciated that the modes may not be optimized solely for productivity, economy, or quality and that additional or different constraints may be applied depending on the mode selected. In addition to the constraints listed above for the optimized printing modes, some of the constraints which may be used, either singly or in combination in creating a printing mode may include those listed in TABLE 1.

TABLE 1
Exemplary Constraints

All black only pages are assigned to the same black marking engine.
All black only pages are assigned to the same or a consistent black
marking engine.
All pages of a black only print job are assigned to a black marking
engine or to a consistent black marking engine.
All pages within the print job having black content (i.e., a black image)
on pages having color content are assigned to a black marking engine
for the black content and to the color marking engine for the color
content.
All pages are assigned to the same color marking engine.
All pages are assigned to the same or to a consistent color marking
engine.
All pages of a print job including both black and color images are
assigned to the same (or to a consistent) color marking engine.
For a duplex (two sided) print job, facing pages with color are assigned
to the same color marking engine.
For a duplex (two sided) print job, facing pages with color are assigned
to the same or to a consistent color marking engine.
For a duplex (two sided) print job, facing pages with only black are
assigned to the same black marking engine.
For a duplex (two sided) print job, facing pages with only black are
assigned to the same or to a consistent black marking engine.
All facing pages of the print job which are of the same print modality
are assigned to the same or to a consistent marking engine.
All pages of a print job which includes any color are assigned to a
color marking engine (or to a consistent color marking engine).

A consistent marking engine is one which achieves image characteristics, such as gloss and color space, which fall within a predetermined acceptable range of that of another consistent marking engine.

The user may be provided with a set of print modes to select from, without requiring the user to have a detailed understanding of the various constraints that the scheduler will apply in realizing the print job.

In one embodiment, the set of modes may include one or more optimized print modes for achieving the goals of productivity, quality, and/or economy, and/or may include one or more modified print modes which, while having a primary goal of productivity, quality, or economy, introduce constraints which take into consideration one of the other goals. For example, in a modified quality printing mode, which provides a compromise between image quality and productivity and/or cost, at least the facing images (e.g., those images appearing on facing pages of a finished document) which are of the same print modality are printed on the same (or a consistent) marking engine, since the eye is more apt to notice any differences between pages viewed at the same time. This allows, for example, non-facing color images to be printed on different color marking engines, where the difference is less noticeable or not-noticeable.

In another embodiment, the user is provided with a set of base print modes, such as the optimized modes for productivity, quality, and economy, described above, and allowed to select one or more optional preferences from a set of preferences, such as one or more of the constraints in Table 1 above. Each mode may have its own set of associated user-selectable preferences. The scheduler applies the user-selected preferences to schedule an itinerary, applying the constraints of the base mode where these do not conflict with the additional user-selected preferences.

In some cases some of the print modes may not be available for printing a particular print job. In this case, the user may be presented with a more limited set of print modes from which to select.

In some cases, a plurality of the print modes may yield an identical itinerary for a particular print job.

It will be appreciated that there may be composite images to be printed, for example, those which include both black portions (black images), such as text, as well as color portions (color images), such as photographs and color drawings. In a first of the print modes, these images may be printed on a single marking engine (a color marking engine). In a second of the print modes, they may be sequentially printed by two or more marking engines, such as a black marking engine for the black image and a color marking engine for the color image. The first mode of operation favors production cost while potentially sacrificing image quality since the imaged print media with a composite image may have a different gloss level from adjacent pages which do not include composite images and which are therefore fused once rather than twice. Additionally, the difficulties associated with registration of the imaged print media in the second marking engine can lead to the two portions of the image lacking optimal alignment. The second mode of operation generally favors image consistency while potentially sacrificing production cost.

With the above understanding of the elements, the operation of the system will be readily understood and appreciated from the following description. The job previewer 204 in conjunction with the scheduler 202 operates to distribute one or more job portions of a print job among one or more marking engines based on the attributes of the print job. In general, the technique proposes an approach in which attribute information associated with a job, i.e. attribute information embedded in an electronic document and corresponding job ticket, is “parsed” and used. A print job is submitted to the computer network/server. The print job, i.e., the electronic document and job ticket associated with the job, is then parsed for information relating to job level attributes.

As will be appreciated, parsing may include nothing more than scanning the job ticket and the electronic document (also referred to as “job master”) to glean necessary attribute information. In conjunction with parsing, the job may be placed into a form suitable for editing. It will be appreciated that a job, when in a PDL format, is not readily edited. Thus to facilitate editing, the job is placed into an intermediate format, e.g. such as TIFF or any other suitable editable format. It should be appreciated that the preferred embodiment contemplates the placing of the job into an intermediate format, whether the job is to be edited or not, because to do so, among other things, facilitates print-on-demand preparation of the job. RIPing of the job to place it into an intermediate format can be achieved readily with a platform of the type disclosed in U.S. Pat. Nos. 5,113,494 and 5,220,674, the disclosures of which are incorporated herein in their entireties, by reference.

Once the job is in a suitable intermediate format, it may be buffered so that appropriate editing procedures can be executed therewith. As will be appreciated, in one example the intermediate format would permit editing at an object oriented level in which image components or objects could be added to or deleted from the document job.

The job previewer 204 determines the job level and page attributes and assigns each page to an appropriate group. The scheduler 202 includes a subroutine which determines which of one or more modes of operation can be used to execute the job. A situation well suited for the present application exists when a print job includes images having a black image and one or more color images. In one example, the job may include multiple color types, such as both process color and accent/highlight color.

In one example, a user is queried by the printing system or network server, in accordance with an interactive scheme, to select a print mode and the users selection is received by user interface 220. Where a scanner or other image source is used, a dedicated user interface 220, such as a keyboard, touch screen, or the like may be provided for inputting user-selected print modes and preferences. Alternatively, the user may input the print mode selection on a network computer or other device remote from the printing system and communicated to the user interface 220, for example, via the interface unit. The user may be asked to select one of the print modes which can be used for the print job. Where a user makes no selection, the printing system selects a default mode, which may be the same as one of the user selectable print modes or a different print mode.

In one exemplary embodiment, the following print modes and associated constraints are provided:

1. Productivity Mode (Optimized for Productivity, Optionally also Used as Default Mode)

Constraint 1: For a black only print job (a print job with no color images), all pages can be assigned to any marking engine capable of printing black.

Constraint 2: For a print job which includes color images, all pages with any color content (a color image) are assigned to a color marking engine.

2. Economy Mode (Optimized for Economy)

Constraint 1. All pages with any black content (a black image) have the black content assigned to a black marking engine. (This includes pages which are all black, as well as pages with black having color overprinting.)

3. Quality Mode A (Optimized Mode)

Constraint 1: All pages are printed on the same color marking engine unless the print job includes no pages with color (generally, black only pages).

Constraint 2: Where the print job includes black only pages (no pages with color), all pages are printed on the same black engine.

4. Quality Mode B (Modified to Have Some Consideration for Productivity)

Same as mode A for simplex print jobs, where printing is on one side of a sheet only.

Facing pages of a duplex print job that includes any color are printed on the same (or optionally a consistent) color marking engine. A duplex print job is considered to be one where at least some of the sheets are printed on both sides

Facing pages of a duplex print job that includes only black are printed on the same (or optionally a consistent) black marking engine.

5. Quality Mode C

For mixed simplex print jobs (those with both color pages and black only pages), pages that include any color are printed on the same (or optionally a consistent) color marking engine. Pages that are black only are printed on the same (or optionally a consistent) black marking engine.

For mixed duplex print jobs (those with both color pages and black only pages), both sides of a sheet are printed on the same (or optionally a consistent) color marking engine.

6. Exemplary Default Mode A

All process color images are assigned to process color marking engines.

All black images are assigned to black marking engines.

All custom color images are assigned to custom color marking engines.

All MICR impressions are assigned to MICR engines.

7. Exemplary Default Mode B

As for Exemplary Default Mode 1, except that

(a) when the default setting is a first level, all pages of the print job are assigned to the color marking engine(s) when at least one page of the print job contains color and all pages of the print job are assigned to the monochrome marking engine when all pages of the print job are devoid of color;

(b) when the default setting is a second level, all sheets (i.e., comprising front and back pages) of the print job having color therein are assigned to a color marking engine;

(c) when the default setting is a third level, all pages of the print job having color therein are assigned to the color marking engine and all pages of the print job devoid of color to the monochrome marking engine(s); and

(d) when the default setting is a fourth level, all color images of the print job are assigned to the color marking engine(s) and all black images of the print job are assigned to the monochrome marking engine(s).

Thus, for example, when the user selected print mode or the default setting is the economy mode, the scheduler 202 may schedule the job to satisfy the specified cost efficiency constraints, without applying constraints relating to productivity and print quality, unless these constraints can be accommodated while achieving the constraints of the economy mode.

It will be appreciated that in a productivity mode for a print job which includes both color and black pages, the color marking engine prints all the pages with any color content but may also print some of the black only pages, depending on the number of black pages to be printed and the availability and capacities of the black marking engine(s).

These modes listed above may include further constraints in addition to those listed. Additionally or alternatively, there may be print modes which include other constraints. For example, if slightly higher image quality is desired in a productivity or economy mode, the scheduler may assign facing pages of the print job to the same marking engine. Or constraints may be provided to take into account temporary unavailability of one or more marking engines. Thus for example, in the event that a black marking engine goes off line, the offline constraint may modify the printing mode to allow black printing on a color marking engine, thus superseding the user selected constraint. In one embodiment, the user is notified that the printing system is unable to print the print job according to the selected mode and may abort the job or select another mode.

In each of the above exemplary print modes, it is assumed that all images are either black images or color images. The blank pages (pages with neither black or color) are ignored. Thus, a print job with “black only” pages may also have blank pages. The modes may use similar constraints custom color images to those for black images. Constraints can be established which address situations where there are both black and custom color images on a page and where custom color and black marking engines are both present in the printing system.

The printing system thus described allows user optimization of jobs for image quality, run cost, and productivity. For instance, if the user has a monochrome production job which needs to be produced as quickly as possible, the user may select a productivity mode for the job in which the black only prints are scheduled to both the process color and black marking engines. In this case the run cost per sheet and print to print image quality consistency may be sacrificed for productivity. For a very quality conscious color customer, a job can be run entirely through the color marking engine to ensure gloss consistency from page to page. If quality is desired, but the user is willing to accept less than the highest quality mode, a mode can be invoked in which the controller schedules jobs such that facing pages are created on the same marking engine.

The system disclosed has redundant black printing capability and a control system 110 that can take advantage of this redundancy in useful ways. The control system can schedule jobs in order to minimize run cost, maximize productivity, maximize image quality, or based on a combination of two or more of cost, productivity, and image quality.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. a printing system comprising:
at least one monochrome marking engine for printing monochrome images;
at least one color marking engine;
a previewer which identifies attributes of a print job comprising a plurality of pages including, for each page of the print job, identifying whether the page includes a monochrome image and identifying whether the page includes a color image;
a user interface which enables a user to select a print mode for the print job from a plurality of user-selectable print modes;
a scheduler, responsive to the previewer and the user interface, for assigning pages of the print job among the marking engines based on the attributes of the print job and the user-selected print mode; and
at least one marking engine controller, in communication with the scheduler, for controlling the at least one monochrome marking engine to render pages of the print job assigned thereto and for controlling the at least one color marking engine to render pages of the print job assigned thereto.

2. The printing system of claim 1, wherein the at least one monochrome marking engine is selected from the group consisting of black (K) marking engines, custom color (C) marking engines, and combinations thereof.

3. The printing system of claim 2, wherein the at least one color marking engine includes a plurality of colorants for printing images with one or more colorant.

4. The printing system of claim 1, wherein the color marking engine prints both monochrome images and color images.

5. The printing system of claim 1, wherein the plurality of user-selectable print modes are selected from the group consisting of an image quality mode, a productivity mode, an economy mode, and a default mode.

6. The printing system of claim 5, wherein when the user-selected print mode is a productivity mode, the scheduler, for the print job, assigns pages which include only monochrome images according to which of the following modes achieves a higher productivity:
assigning pages which include only monochrome images to the at least one monochrome marking engine, and
assigning pages which include only monochrome images to the at least one monochrome marking engine and to the at least one color marking engine.

7. The printing system of claim 6, wherein when the user-selected print modes is a productivity mode, the scheduler assigns all pages within the print job which include a color image to the at least one color marking engine for printing the color images and for printing any black images that are on pages which include a color image.

8. The printing system of claim 5, wherein when the user-selected print modes is a productivity mode, the print job which include a color image to the at least one color marking engine for printing color images and black images.

9. The printing system of claim 5, wherein when the user-selected print mode is an economy mode, the scheduler assigns all pages within the print job with only monochrome images to the at least one monochrome marking engine, for printing the monochrome images, all pages within the print job with only color images to the at least one color marking engine, for printing the color images, and all pages with both color and monochrome images to at least one monochrome marking engine for printing the monochrome image and to at least one color marking engine for printing the color image.

10. The printing system of claim 5, wherein:
when the user-selected print mode is a first image quality mode and the print job includes at least one color image, the scheduler assigns all pages of the print job to the same one of the at least one color marking engine; and
when the user-selected print mode is a first image quality mode and the print job includes only monochrome images, the scheduler assigns all pages of the print job to the same one of the at least one monochrome marking engine.

11. The printing system of claim 5, wherein when the user-selected print mode is a second image quality mode, the scheduler assigns all pages of the print job to any consistent color marking engine selected from the least one color marking engine.

12. The printing system of claim 5, wherein when the user-selected print mode is a third image quality mode, the scheduler assigns all facing pages which include color images to the same one of the at least one color marking engine and optionally also assigns facing pages which include only monochrome images to the same one of the at least one monochrome marking engine.

13. The printing system of claim 5, wherein each of the print modes includes at least one constraint relating to at least one of productivity, image quality and production cost of a print job.

14. The printing system of claim 1, wherein each of the plurality of user-selectable print modes applies at least one constraint to the scheduler and wherein each of the print modes differs from each of the other print modes in at least one constraint.

15. A method for printing comprising:
for a print job having a plurality of pages, in a printing system including at least one monochrome marking engine for printing monochrome images, at least one color marking engine, operatively connected to the monochrome marking engine:
identifying attributes of the print job including, for each page, identifying if the page includes a monochrome image and identifying if the page includes a color image,
establishing a print mode for the print job from a plurality print modes, the plurality of print modes including at least one user-selectable print mode,
assigning pages of the print job among the marking engines based on the attributes of the print job and the user-selected print mode, and
controlling the at least one monochrome marking engine to render pages of the print job assigned thereto and for controlling the at least one color marking engine to render pages of the print job assigned thereto.

16. The method of claim 15, wherein the establishing includes selecting between an image quality mode, a productivity mode, an economy mode, and optionally a default mode.

17. The method of claim 16, wherein:
when the established print mode is a productivity mode, permitting a portion of the monochrome pages to be printed on a color marking engine;
when the established print mode is a first image quality mode and the print job includes color images, printing all pages on the same color marking engine;
when the established print mode is the first image quality mode and the print job includes no color images, printing all monochrome pages on the same monochrome marking engine;
when the established print mode is a second image quality mode, all printing all sheets of the print job having color therein on a color marking engine;
when the established print mode is a third image quality mode, printing all pages of the print job having color therein on a color marking engine and all pages of the print job devoid of color on a monochrome marking engine; and
when the established print mode is a fourth image quality mode, printing all color images of the print job on a color marking engine and all black images of the print job on a monochrome marking engine.

18. A xerographic printing system comprising:
at least a first marking engine which prints images of a first type but which does not print images of a second type;
at least a second marking engine which prints images of the first type and images of the second type;
a user interface which enables a user to select a print mode from a plurality of print modes including:
a first print mode in which all pages of the print job which have an image of the first type are assigned to the first marking engine for printing the image of the first type and in which pages of the print job having an image of the first type and also an image of the second type, are also assigned to the second marking engine for printing images of the second type; and
a second print mode in which at least a portion of the pages having only images of the first type are assigned to the at least one second marking engine;
the printing system executing the print job according to the print mode selected.

19. The xerographic printing system of claim 18, further comprising a finisher which receives media printed by the marking engine of the first type and the marking engine of the second type.

20. The xerographic printing system of claim 19, further comprising a conveyor system which conveys the printed media from the first and second marking engines to the finisher.

21. The xerographic printing system of claim 18, wherein the marking engine of the first type is a black marking engine and the marking engine of the second type is a color marking engine.

22. The xerographic printing system of claim 21, wherein the color marking engine includes a black colorant.
